(19) United States
(12) Patent Application Publication
(10) Pub. No.: US 2015/0104105 A1
(43) Pub. Date: Apr. 16, 2015

(54) COMPUTING DEVICE AND METHOD FOR JOINTING POINT CLOUDS

(71) Applicants: Fu Tai Hua Industry (Shenzhen) Co., Ltd., Shenzhen (CN); HON HAI PRECISION INDUSTRY CO., LTD., New Taipei (TW)

(72) Inventors: XIN-YUAN WU, Shenzhen (CN); CHIH-KUANG CHANG, New Taipei (TW); PENG XIE, Shenzhen (CN)

(21) Appl. No.: 14/513,396

(22) Filed: Oct. 14, 2014

(30) Foreign Application Priority Data
Oct. 14, 2013 (CN) 201310476517.3

(51) Int. Cl. G06K 9/46; G06K 9/62; G06T 5/10

(52) U.S. Cl. CPC G06K 9/4604; G06T 5/10; G06K 9/6201
USPC 382/199

(57) ABSTRACT

A computing device and a method joints point clouds of an object into a coordinate system. The computing device calculates edge points of each image, and calculates a curvature scale space (CSS) corner of each image according to the edge points of each image. The computing device calculates a sub-pixel corner of each image according to the CSS corner of each image, and matches a sub-pixel corner of each image to obtain common corners. The computing device calculates a transmitting matrix using the common corners, and transmits all point clouds in the coordinate system using the transmitting matrix.

### CROSS-REFERENCE TO RELATED APPLICATIONS

This application claims priority to Chinese Patent Application No. 201310476517.3 filed on Oct. 14, 2013, the contents of which are incorporated by reference herein.

### FIELD

Embodiments of the present disclosure relate to a simulation technology, and particularly to a computing device and a method for jointing point clouds.

### BACKGROUND

Computerized numerical control (CNC) machines are used to process components of objects (for example, a shell of a mobile phone). However, CNC machines may fail when ran many times. For example, a blade of a CNC machine may need to be periodically changed.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a block diagram of an example embodiment of a computing device.

FIG. 2 illustrates a block diagram of an example embodiment of a point cloud jointing system included in the computing device.

FIG. 3A-3B shows a diagrammatic view of an example of a process for calculating a sub-pixel corner.

FIG. 4 is a flowchart of an example embodiment of a method for jointing point clouds.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

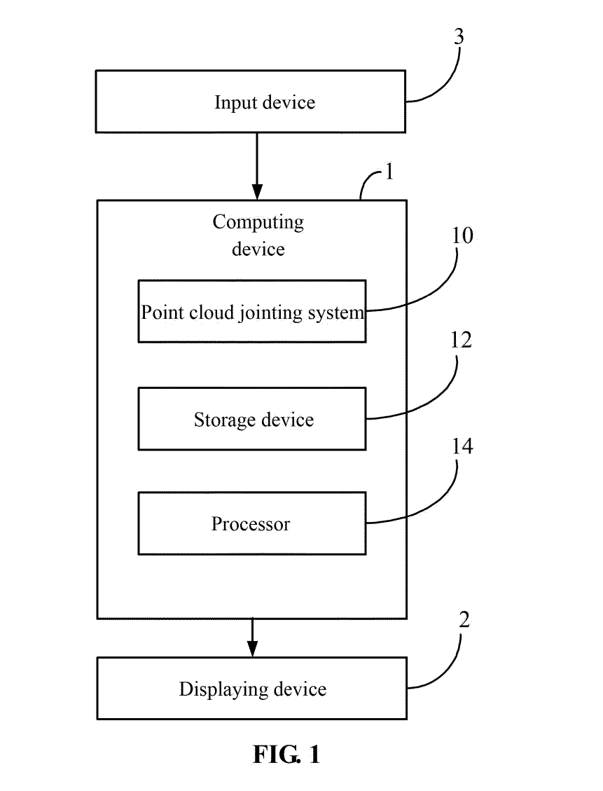

FIG. 1 illustrates a block diagram of an example embodiment of a computing device 1. In the embodiment, the computing device 1 provides various functional connections to connect with a displaying device 2, and an input device 3. The computing device 1 provides a user interface, which is displayed on the displaying device 2. One or more operations of the computing device 1 can be controlled by a user through the user interface. For example, the user can input an ID and a password using the input device 3 (e.g., a keyboard and a mouse) into the user interface to access the computing device 1. The computing device 1 is used to scan an object (not shown) to obtain a plurality of point clouds of the object. The object may be, but is not limited to, a component (e.g., a shell) of an electronic device (e.g., a mobile phone). The point clouds of the object are three-dimensional. That is, each point in the point clouds includes an X-axis value, a Y-axis value and a Z-axis value. Furthermore, the computing device 1 includes a charge coupled device (CCD) and a camera, which are used to capture images of the object. The displaying device 2 further displays the point clouds and images of the object, so that the point clouds and images of the object can be visually checked by the user. The computing device 1 can be, but is not limited to, a three-dimensional scanner capable of emitting light which is projected onto the object. In the example embodiment, the computing device 1 includes, but is not limited to, a point cloud jointing system 10, a storage device 12, and at least one processor 14. FIG. 1 illustrates only one example of the computing device 1, and other examples can comprise more or fewer components than those shown in the embodiment, or have a different configuration of the various components.

In one embodiment, the storage device 12 can be an internal storage device, such as a flash memory, a random access memory (RAM) for temporary storage of information, and/or a read-only memory (ROM) for permanent storage of information. The storage device 12 can also be an external storage device, such as an external hard disk, a storage card, or a data storage medium. The at least one processor 14 can be a central processing unit (CPU), a microprocessor, or other data processor chip that performs functions of the computing device 1. The storage device 12 stores the three-dimensional point clouds of the object and the images of the object.

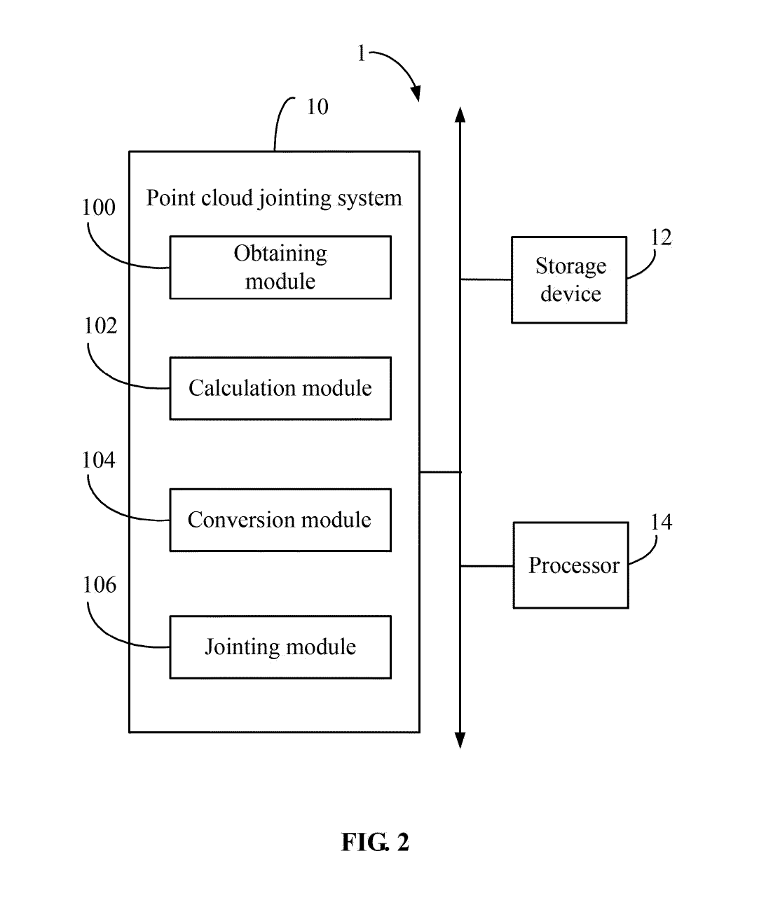

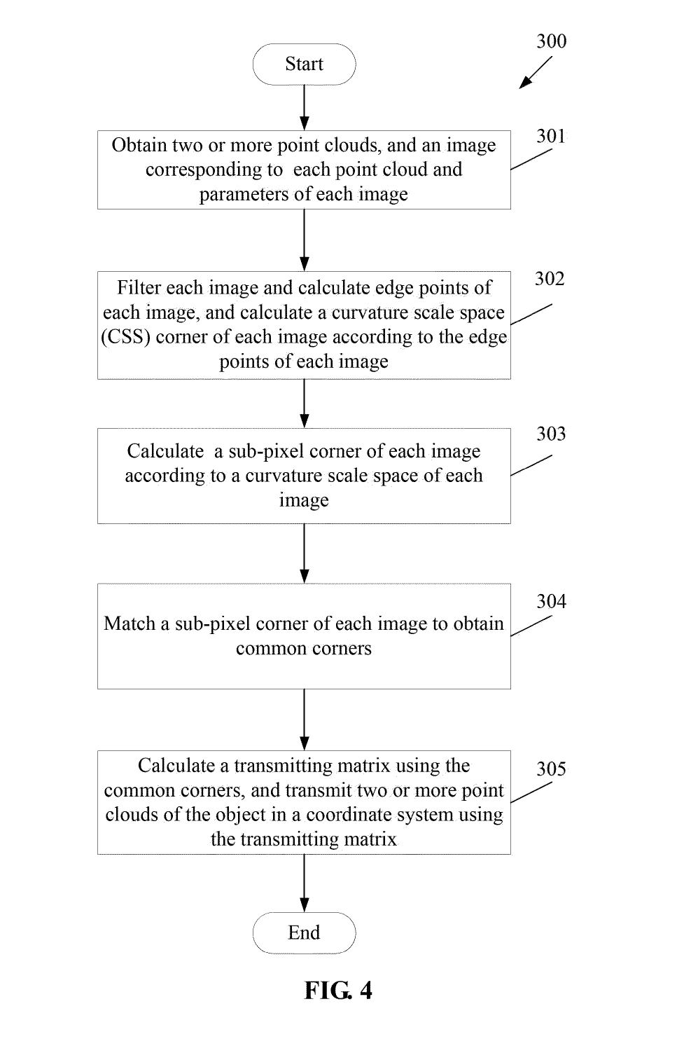

FIG. 2 illustrates a block diagram of an example embodiment of the point cloud jointing system 10 included in the computing device 1. In one embodiment, the point cloud jointing system 10 can include, but is not limited to, an obtaining module 100, a calculation module 102, a conversion module 104 and a jointing module 106. The modules 100-106 can comprise computerized instructions in the form of one or more computer-readable programs that can be stored in a non-transitory computer-readable medium, such as the storage device 12, and be executed by the at least one processor 14 of the computing device 1. Detailed descriptions of functions of the modules are given below in reference to FIG. 4.

FIG. 4 illustrates a flowchart of an example embodiment of a method for jointing point clouds. In an example embodiment, the method is performed by execution of computer-readable software program codes or instructions by at least one processor of a computing device.

Referring to FIG. 4, a flowchart is presented in accordance with an example embodiment. The method 300 is provided by way of example, as there are a variety of ways to carry out the method. The method 300 described below can be carried out using the configurations illustrated in FIGS. 1 and 4, for example, and various elements of these figures are referenced in explaining example method 300. Each block shown in FIG. 4 represents one or more processes, methods, or subroutines, carried out in the method 300. Furthermore, the illustrated order of blocks is illustrative only and the order of the blocks can be changed. Additional blocks can be added or fewer blocks may be utilized without departing from this disclosure. The example method 300 can begin at block 301.

In block 301, the obtaining module 100 obtains two or more point clouds of the object, an image corresponding to each point cloud of the object and parameters of each image from the storage device 12. In one embodiment, if the computing device 1 at a location scans the object to obtain a point cloud of the object, and the computing device 1 captures the image of the object at the same location, the image is determined to correspond to the point cloud of the object. For example, the point cloud is obtained at the location A by the computing device 1, the image is still captured at the location A by the computing device 1, then the image is related to the point cloud. The parameters of each image can include a focus of the camera of the computing device 1, and a centre point of the CCD of the computing device 1.

In block 302, the calculation module 102 filters each image and calculates edge points of each image using a canny algorithm, and calculates a curvature scale space (CSS) corner of each image according to the edge points of each image. In one embodiment, the calculation module 102 filters each image using a gauss filter. After filtering process, the edge points of each image are represented as a formula as following:

Γ(u)=[X(u,δ),Y(u,δ)],

where X(u,δ) represents a horizontal coordinate and Y(u,δ) represents a vertical coordinate. A curvature of each edge point is calculated. The edge point is determined to be a CSS corner when the edge point meets three conditions: (1) the curvature of the edge point is maximum comparing to the curvatures of other calculated edge points, (2) the curvature of the edge point is greater than a predetermined threshold, and (3) the curvature of the edge point is at least twice greater than a minimum curvature selected from curvatures of other edge points adjacent to the edge point. In addition, if the CSS corner is adjacent to a T-type corner, then T-type corner is deleted.

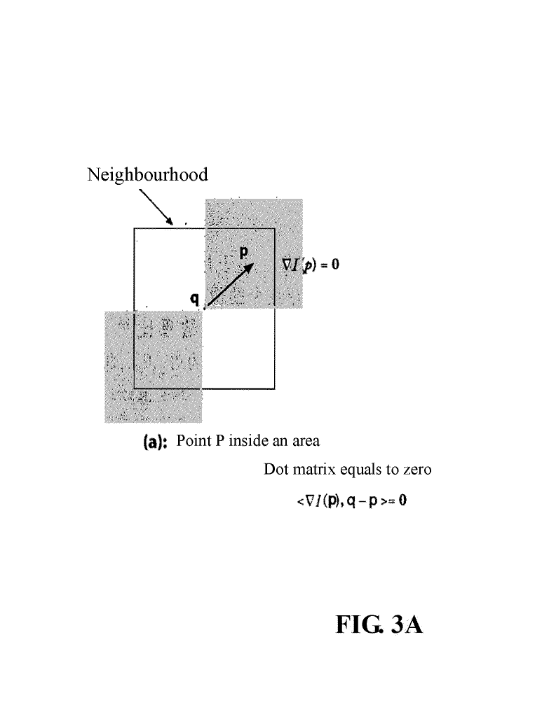

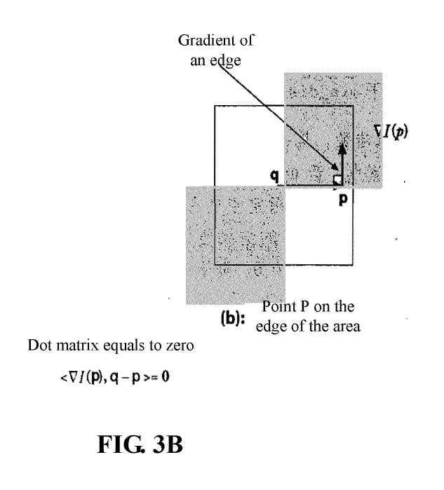

In block 303, the calculation module 102 calculates a sub-pixel corner of each image according to the CSS corner of the image. The CSS corner of the image is processed by a spline interpolation function, so that the sub-pixel corner of the image is obtained. In one embodiment, as shown in FIG. 3A-3B, assuming that q is a sub-pixel corner, p is a CSS corner, then all vectors of q-p are detected. For a situation (a) as shown in FIG. 3A, p of the image is located at a uniform area, a gradient of p equals to zero. For another situation (b) as shown in FIG. 3B, p is located at an edge area, a direction of the vector of q-p is the same as the direction of the edge, the gradient of p are orthogonal to the vector of q-p. Like the two situations, a plurality of the gradients are searched around the area of the CSS corner p as the situation (a), and the vectors of q-p are searched as the situation (b), and a dot matrix corresponding to the gradients and the vector of q-p is generated, where the dot matrix equals to zero. The solution of the dot matrix is a location of the sub-pixel corner q.

In block 304, the conversion module 104 matches a sub-pixel corner of each image using an invariant theory of Euclidean space to obtain common corners. Each common corner belongs to two or more images. Furthermore, the conversion module 104 converts the common corner into a three-dimensional coordinates according to the parameters of each image. The invariant theory of Euclidean space includes one or more constraint conditions, for example, a distance constraint condition, an angle constraint condition, and an area constraint condition. Using the distance constraint condition to obtain the common corner as: (1) assuming that Q is a group including two or more sub-pixel corners of an image, and all distances between any two sub-pixel corners of the image in Q are calculates; (2) assuming that P is a group including two or more sub-pixel corners of another image, and common corners between Q and P are searched. All distances between any two sub-pixel corners of the image in P are calculates and P1 is a sub-pixel corner in P, search for two distances from P1 to any other sub-pixel corners in P and determines if the two distances includes in Q. If the two distances includes in Q, then P1 is determined to be a common corner.

In block 305, the jointing module 106 calculates a transmitting matrix using the common corners, and transmits two or more point clouds of the object in a coordinate system using the transmitting matrix. The transmitting matrix is calculated using a triangulation algorithm, a least square method, a singular value decomposition (SVD) method, or a quaternion algorithm.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A computing device, comprising:
at least one processor; and
a storage device that stores one or more programs, which when executed by the at least one processor, cause the at least one processor to:
obtain two or more point clouds of an object, and an image corresponding to each point cloud of the object, from the storage device;
filter each image;
calculate edge points of each image;
calculate a curvature scale space (CSS) corner of each image according to the edge points of each image;
calculate a sub-pixel corner of each image according to the CSS corner of each image;
match a sub-pixel corner of each image to obtain common corners;
calculate a transmitting matrix using the common corners; and
transmit two or more point clouds of the object in a coordinate system using the transmitting matrix.

2. The computing device of claim 1, wherein each image is determined to correspond to a point cloud of the object upon the condition that the computing device at a location scans the object to obtain the point cloud of the object while the computing device captures the image of the object at the same location.

3. The computing device of claim 1, wherein the parameters of each image comprises a focus of a camera of the computing device, and a centre point of a charge coupled device (CCD) of the computing device.

4. The computing device of claim 1, wherein each image is filtered using a gauss filter.

5. The computing device of claim 1, wherein the edge points of each image are calculated using a canny algorithm.

6. The computing device of claim 1, wherein the edge point is determined to be a CSS corner when the edge point meets three conditions: (1) the curvature of the edge point is maximum comparing to the curvatures of other calculated edge points, (2) the curvature of the edge point is greater than a predetermined threshold, and (3) the curvature of the edge point is at least twice greater than a minimum curvature selected from curvatures of other edge points adjacent to the edge point.

7. The computing device of claim 1, wherein the CSS corner of the image is processed by a spline interpolation function to obtain the sub-pixel corner of the image.

8. The computing device of claim 1, wherein the sub-pixel corner of each image is matched using an invariant theory of Euclidean space.

9. The computing device of claim 1, wherein each common corner belongs to two or more images.

10. The computing device of claim 1, wherein the transmitting matrix is calculated using a method selected from a group consisting of a triangulation algorithm, a least square method, a singular value decomposition (SVD) method, and a quaternion algorithm.

11. A computer-based method for jointing point clouds using a computing device, the method comprising:
obtaining two or more point clouds of an object, and an image corresponding to each point cloud of the object from a storage device of the computing device;
filtering each image and calculating edge points of each image, and calculating a curvature scale space (CSS) corner of each image according to the edge points of each image;
calculating a sub-pixel corner of each image according to the CSS corner of each image;
matching a sub-pixel corner of each image to obtain common corners; and
calculating a transmitting matrix using the common corners, and transmitting two or more point clouds of the object in a coordinate system using the transmitting matrix.

12. The method of claim 11, wherein each image is determined to correspond to a point cloud of the object upon the condition that the computing device at a location scans the object to obtain the point cloud of the object while the computing device captures the image of the object at the same location.

13. The method of claim 11, wherein the parameters of each image comprises a focus of a camera of the computing device, and a centre point of a charge coupled device (CCD) of the computing device.

14. The method of claim 11, wherein each image is filtered using a gauss filter.

15. The method of claim 11, wherein the edge points of each image are calculated using a canny algorithm.

16. The method of claim 11, wherein the edge point is determined to be a CSS corner when the edge point meets three conditions: (1) the curvature of the edge point is maximum comparing to the curvatures of other calculated edge points, (2) the curvature of the edge point is greater than a predetermined threshold, and (3) the curvature of the edge point is at least twice greater than a minimum curvature selected from curvatures of other edge points adjacent to the edge point.

17. The method of claim 11, wherein the CSS corner of the image is processed by a spline interpolation function to obtain the sub-pixel corner of the image.

18. The method of claim 11, wherein the sub-pixel corner of each image is matched using an invariant theory of Euclidean space.

19. The method of claim 11, wherein each common corner belongs to two or more images.

20. The method of claim 11, wherein the transmitting matrix is calculated using a method selected from a group consisting of a triangulation algorithm, a least square method, a singular value decomposition (SVD) method, and a quaternion algorithm.
